(19) United States
(12) Patent Application Publication
(10) Pub. No.: US 2007/0294397 A1
(43) Pub. Date: Dec. 20, 2007

(54) Physical presence indication for a collaborative communication

(75) Inventor: Michael C. Kunz, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/454,232

(22) Filed: Jun. 16, 2006

(51) Int. Cl. G06F 15/173

(52) U.S. Cl. 709/224

(57) ABSTRACT

A physical presence indicator as described herein generates indicia of the real-time user presence status for one or more users of a collaborative communication application, such as an instant messaging application. The physical presence indicator communicates with the collaborative communication application, which may be hosted by a computing device. The physical presence indicator conveys the real-time user presence status outside the domain of the graphical user interface of the collaborative communication application. One example implementation utilizes an illumination element that is controlled to have at least two states, where one state indicates an “available” user presence condition and the other state indicates an “unavailable” user presence condition. The illumination element is distinct from, and external to, the computing device.

### BACKGROUND

Collaborative communication systems and applications enable users to communicate with one another in real-time. Such collaborative communication applications include instant messaging applications, software-based telephone systems, interactive video game systems, and other applications deployed over a network. The concept of user presence or the availability of an individual to communicate is a key component of such real-time communication applications. User presence is often displayed by the computer system hosting the collaborative communication application. For example, an instant messaging application may generate a display of a list of users along with their respective presence status, e.g., “online,” “available,” “offline,” “do not disturb,” “out of the office,” or the like. Such user presence information may include the real-time status of the local user of the host computer system, along with the real-time status of one or more additional users of the instant messaging application (e.g., persons in the local user's contacts list or address book). The local user can manipulate the graphical user interface of the instant messaging application to change his or her current presence status in real-time, and the updated presence status will be visible by other users of the instant messaging application.

### BRIEF SUMMARY

The techniques and technologies described herein can be utilized to indicate real-time user presence status for a collaborative communication application, such as an instant messaging application. A physical presence indicator communicates with the collaborative communication application to receive indicator control signals that control the operation of the physical presence indicator. The physical presence indicator is a tangible device that presents indicia of the real-time user presence status outside of the normal graphical user interface environment of the host computer system.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of an example embodiment may be derived by referring to the detailed description and claims when considered in conjunction with the following figures, wherein like reference numbers refer to similar elements throughout the figures.

FIG. 1 is a simplified schematic representation of an example computer system for implementing an example embodiment;

FIG. 2 is a schematic representation of a network environment for implementing an example embodiment;

FIG. 3 is a schematic representation of an example presence indicator device in a first indicating state;

FIG. 4 is a schematic representation of an example presence indicator device in a second indicating state; and

FIG. 5 is a flow diagram of a presence indication process corresponding to an example embodiment.

### DETAILED DESCRIPTION

The following detailed description is merely illustrative in nature and is not intended to limit the embodiments described herein or the application and uses of such embodiments. Furthermore, there is no intention to be bound by any expressed or implied theory presented in the preceding technical field, background, brief summary or the following detailed description.

Example embodiments may be described herein in terms of functional and/or logical block components and various processing steps. It should be appreciated that such block components may be realized by any number of hardware, software, and/or firmware components configured to perform the specified functions. For example, an embodiment may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that practical embodiments may be practiced in conjunction with any number of data transmission protocols and that the system described herein is merely one example embodiment.

For the sake of brevity, conventional techniques related to computer devices, collaborative communication applications, data transmission, network control, computer operating systems, device drivers, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an example embodiment.

The following description may refer to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 2 depicts one example arrangement of elements, additional intervening elements, devices, features, or components may be present in an example embodiment (assuming that the functionality of the system is not adversely affected).

In conventional collaborative communication systems, user presence information is often hidden in (or missing from) the actual physical environment. In this regard, conventional systems display user presence status in the graphical user interface of the collaborative communication application itself, and, therefore, the user presence status information may be difficult to view from a distance or hidden from view by other displayed elements (for example, if the collaborative communication application is minimized on the user's display monitor). In contrast, the example embodiment described herein provides a physical display, indication, or notification of real-time user presence status associated with one or more collaborative communication applications, where the physical presence indication is external to the graphical user interface of the host computer system. A physical presence indicator device may also allow the user to select his presence status on the indicator device; the selected presence status can then be reflected on the host computer system and/or updated by the collaborative communication application for network user display. In this manner, the presence indicator device allows a person to build on their online identity and represent their online status in the physical world.

FIG. 1 is a simplified schematic representation of an example computer system 100 for implementing an example embodiment. Computer system 100 is only one example of a suitable operating environment and is not intended to suggest any limitation as to the scope of use or functionality of any practical embodiment. Other well known computing systems, environments, and/or configurations that may be suitable for use include, but are not limited to, personal computers, server computers, hand-held or laptop devices, personal digital assistants, mobile telephones, multiprocessor systems, microprocessor-based systems, programmable consumer electronics, network PCs, minicomputers, mainframe computers, distributed computing environments that include any of the above systems or devices, and the like.

Computer system 100 and certain aspects of the example embodiments may be described in the general context of computer-executable instructions, such as program modules, executed by one or more computers or other devices. Generally, program modules include routines, programs, objects, components, data structures, and/or other elements that perform particular tasks or implement particular abstract data types. Typically, the functionality of the program modules may be combined or distributed as desired in various embodiments.

Computer system 100 typically includes at least some form of computer readable media. Computer readable media can be any available media that can be accessed by computer system 100 and/or by applications executed by computer system 100. By way of example, and not limitation, computer readable media may comprise computer storage media and communication media. Computer storage media includes volatile, nonvolatile, removable, and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computer system 100. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

Referring again to FIG. 1, in its most basic configuration, computer system 100 typically includes at least one processing unit 102 and a suitable amount of memory 104. Depending on the exact configuration and type of computing system 100, memory 104 may be volatile (such as RAM), non-volatile (such as ROM, flash memory, etc.) or some combination of the two. This most basic configuration is identified in FIG. 1 by reference number 106. Additionally, computer system 100 may also have additional features/functionality. For example, computer system 100 may also include additional storage (removable and/or non-removable) including, but not limited to, magnetic or optical disks or tape. Such additional storage is illustrated in FIG. 1 by removable storage 108 and non-removable storage 110. Memory 104, removable storage 108, and non-removable storage 110 are all examples of computer storage media as defined above.

Computer system 100 may also contain communications connection(s) 112 that allow the system to communicate with other devices. Communications connection(s) 112 may be associated with the handling of communication media as defined above. As explained in more detail below, communication connection(s) 112 may be utilized to facilitate the exchange of user presence information, indicator actuator signals, indicator control signals, and/or other data, information, or signals between computer system 100 and a presence indicator device.

Computer system 100 may also include or communicate with input device(s) 114 such as a keyboard, a mouse or other cursor pointing device, a pen, a voice input device, a touch input device, a webcam device, a microphone, etc. Although the example embodiment described herein utilizes a mouse device, embodiments can be equivalently configured to support a trackball device, a joystick device, a touchpad device, or any type of general purpose pointing device. Computer system 100 may also include or communicate with output device(s) 116 such as a display monitor, speakers, a printer, or the like. All of these devices are well know in the art and need not be discussed at length here. As described in more detail below, an example embodiment may incorporate the functionality of a presence indicator device into a suitably configured computer accessory device, e.g., an input device 114 and/or an output device 116.

FIG. 2 is a schematic representation of a network environment 200 for implementing an example embodiment of a physical presence indicator. Network environment 200 includes a suitably configured system for indicating user presence in connection with one or more collaborative communication applications. In this example, the system generally includes a computing device 202 and a presence indicator device 204 that is in communication with computing device 202. Computing device 202 may be coupled to presence indicator device 204 using any suitable communication link 206, which may be a wired link, a wireless link, or a link that combines wired and wireless technologies.

Computing device 202 may, for example, be a general purpose computing system such as computer system 100. Computing device 202 is configured to support or host a collaborative communication application 208 for a plurality of users. In this regard, collaborative communication application 208 may be installed on computer device 202, or it may be accessed remotely by computing device 202 for purposes of virtual presentation to the user of computing device 202. In this example, the current user of computing device 202 is considered the “first person” user of collaborative communication application 208, and “third person” users of collaborative communication application 208 are potentially able to communicate in real-time with the first person user. Such real-time communication may be carried out using any suitable technologies, techniques, or protocols. For example, such real-time communication may utilize an appropriate data communication network 210 such as the Internet, a cellular service network, a paging service network, a WLAN, a LAN, a PBX, or the like. In practice, collaborative communication application 208 may be a real-time messaging application, a real-time telecommunication application, a real-time calendar application, a real-time scheduling application, an interactive video game application, an online chat room application, or the like.

Collaborative communication application 208 may receive, manage, process, or otherwise handle user presence information 212 that represents the real-time status of the users of collaborative communication application 208. Presence information 212 is updated in response to changes in user availability status. For example, presence information 212 may indicate whether a given user of collaborative communication application 208 is currently: available; unavailable; online; offline; on vacation; out of the office; in a meeting; etc. The number of different user presence status types and the specific labels or descriptors for the user presence status types may be determined by the particular collaborative communication application 208. In one example embodiment, user presence information 212 may be shared by multiple applications such that a change in user status initiated by collaborative communication application 208 is reflected in all of the shared applications. Such an embodiment ensures a consistent user presence status across multiple platforms and domains.

Presence information 212a may be maintained locally by collaborative communication application 208. Alternatively (or additionally), presence information 212b may be maintained remotely in a suitably configured database 214. In this regard, network environment 200 may also include a presence manager 216 that manages, controls, and processes the current user presence status for the users of collaborative communication application 208. Presence manager 216 may be realized in a suitably configured network server system or architecture, and presence manager 216 may be coupled to network 210 and database 214 to facilitate updating of user presence information 212b. In this example, presence manager 216 provides the real-time presence data to collaborative communication application 208 via network 210.

As described in more detail below, presence indicator device 204 may be realized as a physical component that is distinct from (and external to) computing device 202. More specifically, presence indicator device 204 is distinct from and external to the graphical user interface of computing device 202. Accordingly, in one example embodiment, computing device 202 includes an indicator driver 218 that is suitably configured to generate indicator control signals in response to manipulation of collaborative communication application 208, where the indicator control signals influence the operation of presence indicator device 204. For example, the first person user of collaborative communication application 208 may alter his or her online presence status using a graphical user interface generated by computing device 202. This manipulation of collaborative communication application 208 causes indicator driver 218 to respond in an appropriate manner; indicator driver 218 may obtain the updated user presence status information for the first person user and generate a corresponding indicator actuator signal having appropriate characteristics and formatting for controlling the operation of presence indicator device 204.

Indicator driver 218 may be realized in collaborative communication application 208, it may be realized in another application installed on computing device 202, or it may be a functional component of the operating system of computing device 202. In practice, indicator driver 218 is coupled to presence indicator device 204 such that the indicator control or actuator signals generated by indicator driver 218 can be received and processed by presence indicator device 204. Indicator driver 218 may employ any suitable device driver technology or technique, and conventional aspects of device drivers will not be described in detail herein.

As mentioned previously, presence indicator device 204 may be coupled to computing device 202 using an appropriate communication link 206. Communication link 206 may be a wireless link, a wired link, or a combination thereof. Communication link 206 may be designed to be compliant with one or more data communication techniques, technologies, standards, specifications, or protocols. For example, communication link 206 may be compliant with any of the following, without limitation: wired USB technology; wireless USB technology; BLUETOOTH wireless technology; IEEE 802.11 wireless technology (any variation); Ethernet networking protocols; RF; IrDA (infrared); ZigBee (and other variants of the IEEE 802.15 protocol); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; hospital or health care facility network protocols, which may be wired or wireless such as those operating in the WMTS bands; GPRS; home network communication protocols; and IEEE 1394 (Firewire).

Presence indicator device 204 is generally configured to provide a real world physical notification of the real-time user presence status of one or more users of collaborative communication application 208. In one embodiment, presence indicator device 204 provides a physical indication of the first person user's presence status. In another embodiment, presence indicator device 204 provides a physical indication of a third person user's presence status. For example, the first person user of computing device 202 may configure the system such that presence indicator device 204 indicates the current presence status of the first person user's spouse, child, supervisor, or any selectable third person user of collaborative communication application 208. In practice, the tangible notification generated by presence indicator device 204 can be more conspicuous than the conventional presence display presented by the graphical user interface of computing device 202. Indeed, presence indicator device 204 can be physically located, sized, shaped, and operated such that the first person user and other people in the vicinity of computing device 202 can quickly and easily ascertain the real-time presence status.

In this example embodiment, presence indicator device 204 includes a physical indication architecture 220, a communication interface 222, and an optional user interface 224. Depending upon the system implementation, presence indicator device 204 may also include an indicator driver 226. Some or all of these components may be coupled together using a bus or any suitable interconnection arrangement 228.

Communication interface 222 is configured to communicate with computing device 202 via communication link 206. Accordingly, communication interface 222 may include hardware, software, and/or firmware that is suitably configured to be compliant with the particular data communication scheme or schemes supported by communication link 206, including any of the data communication techniques, technologies, standards, specifications, or protocols listed above. In one embodiment, communication interface 222 is coupled to indicator driver 218 to facilitate reception of indicator control or actuator signals from indicator driver 218. In another embodiment, communication interface 222 is coupled to collaborative communication application 208 to facilitate reception of user presence information 212 (or data/signals indicative of user presence information 212). Regardless of the particular deployment, the signals received by communication interface 222 will convey real-time user presence status for at least one user of collaborative communication application 208.

If the system employs indicator driver 218, then communication interface 222 may receive the indicator control/actuation signals generated by indicator driver 218, and forward the indicator control/actuation signals to physical indication architecture 220. In another example embodiment, the system may utilize indicator driver 226 in lieu of indicator driver 218. In such an embodiment, indicator driver 226 may be coupled between communication interface 222 and physical indication architecture 220. Indicator driver 226 is generally configured to function as described above for indicator driver 218, however, indicator driver 226 receives (from communication interface 222) the indicator control signals or the user presence information 212. In response to its input signals, indicator driver 226 generates indicator actuation signals for physical indication architecture 220.

Physical indication architecture 220 is configured to generate and present indicia of the real-time user presence status in response to received indicator actuator signals. Again, the indicator actuator signals may originate at computing device 202 or at presence indicator device 204 itself. Physical indication architecture 220 may include hardware, software, and/or firmware that is suitably configured to convert the indicator actuator signals into physically distinguishable notifications of user presence status. For example, physical indication architecture 220 may include any number of the following elements, without limitation: illumination elements such as LED lights, light bulbs, or display elements; text display elements; a media player, such as an audio device, a video device, a speaker, or the like; a mechanically actuated apparatus, such as a flag, a switch, a button, or the like.

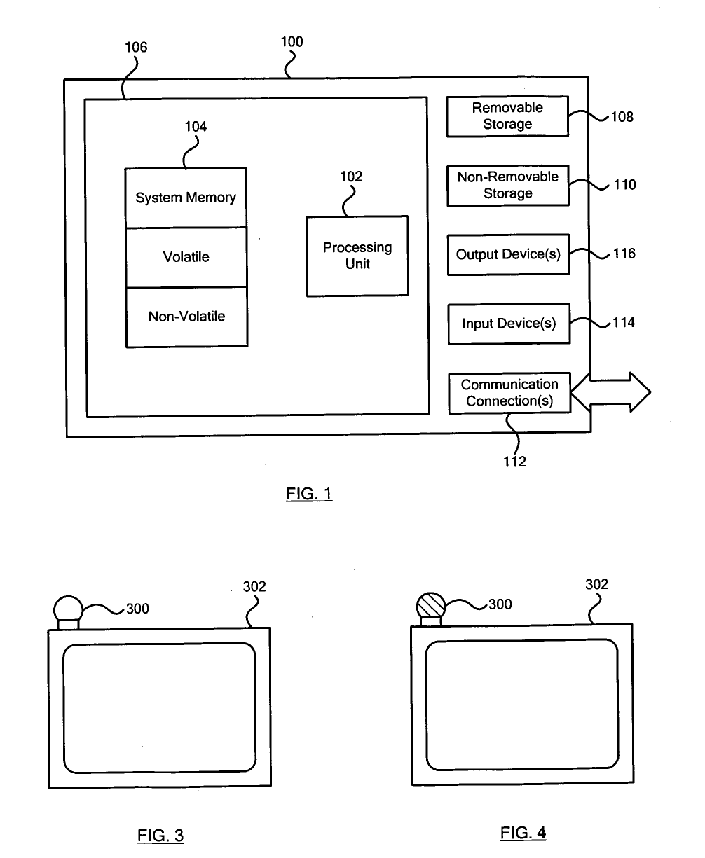

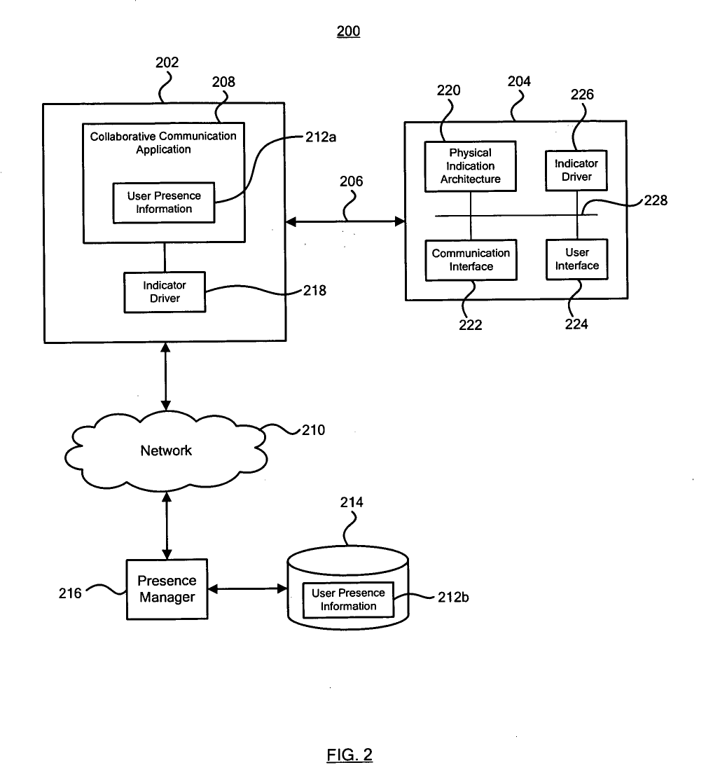

The elements utilized by physical indication architecture 220 are controlled such that different user presence status conditions can be easily distinguished by someone in the vicinity of computing device 202. At a minimum, physical indication architecture 220 is configured to present first indicia in response to a first indicator control/actuator signal, where the first indicia corresponds to a first user presence status (e.g., “available”), and to present second indicia in response to a second indicator control/actuator signal, where the second indicia corresponds to a second and different user presence status (e.g., “unavailable”). As an example, FIG. 3 is a schematic representation of a presence indicator device 300 in a first indicating state, while FIG. 4 is a schematic representation of presence indicator device 300 in a second indicating state. In this example, the physical indication architecture of presence indicator device 300 is mounted to the top of a display monitor 302 of a host computing device. Such a mounting location may be desirable to ensure that the physical indication architecture remains visible and conspicuous. In FIG. 3, the physical indication architecture of presence indicator device 300 is unlit (or it may be illuminated in a first color). In FIG. 4, however, the physical indication architecture of presence indicator device 300 is lit (or it may be illuminated in a second color) to represent that the user presence status has changed. As one example, an unlit condition may indicate that the user is available, while a lit condition may indicate that the user is unavailable. An alternate embodiment may utilize a mechanically actuated flag that, when raised, indicates that the user is unavailable.

FIG. 3 and FIG. 4 depict a simple implementation having one physical indicator that has only two states. In practice, physical indication architecture 220 may include any number of individual physical indicators (e.g., multiple LEDs, multiple text displays, multiple flags, or the like) assigned to any number of users. Moreover, one physical indicator (e.g., an LED or a text display) may be capable of conveying any number of different user presence status conditions. For example, a single illumination element may be configured to generate any number of different colors, to generate light having any number of different intensities, to generate any number of different flashing light patterns, or the like. In practice, the system can support a wide variety of implementations and deployments and it would be impractical to describe every possible alternative embodiment here.

Presence indicator device 204 may also include or cooperate with user interface 224. User interface 224 may be integrated into presence indicator device 204 itself, or it may be a distinct component that is coupled to presence indicator device 204. User interface 224 may include any of the following elements and any number of the individual elements, without limitation: a button; a switch; a keypad; a touch pad; a touch screen; a stylus pad; a cursor pointing device; or the like.

User interface 224 is suitably configured to generate or initiate a local indicator actuator signal for presence indicator device 204. In turn, physical indication architecture 220 responds to the local indicator actuator signal and presents indicia of a user-controlled status, where the user-controlled status is governed by the local indicator actuator signal. Notably, the local indicator actuator signal can be generated independently from collaborative communication application 208.

As an example, user interface 224 may be realized as a two-state switch or button having an “available” state and an “unavailable” state. The user can physically actuate this switch/button to control his or her physical presence indication on presence indicator device 204. This manual control may be independent of the user's presence status maintained by collaborative communication application 208, or the manual control may result in an updating of user presence information 212. Thus, communication interface 222 may be suitably configured to provide, in response to the local indicator actuation signal, a user presence status change command for collaborative communication application 208. This status change command may be transmitted to computing device 202 and/or to presence manager 216 such that the corresponding user presence information 212 is updated for presentation at computing device 202 and possibly other networked devices.

Computing device 202 may include one or more computer accessory devices coupled thereto. Referring again to FIG. 1, a computer accessory device may be configured to operate as an input device 114 and/or an output device 116 for computing device 202. In one implementation of the system, presence indicator device 204 is incorporated into the computer accessory device. For example, presence indicator device 204 may be realized as an illumination element that is incorporated into a cursor pointing device such as a mouse or a trackball. As another example, presence indicator device 204 may be realized as an illumination element that is incorporated into a webcam accessory that is mounted to the top of the display monitor for computing device 202. Moreover, the native user interface features of the computer accessory device may be leveraged and configured to also function as the user interface 224 for presence indicator device 204.

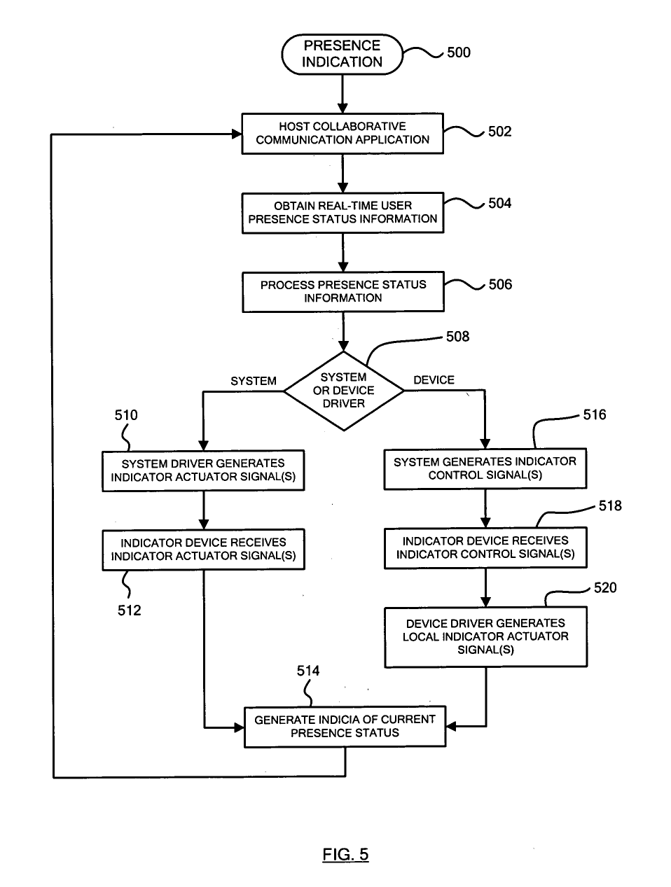

FIG. 5 is a flow diagram of a presence indication process 500 corresponding to an example embodiment. Process 500 may be performed to provide a physical indication of the presence of one of more users of a collaborative communication application. The various tasks performed in connection with process 500 may be performed by software, hardware, firmware, or any combination thereof. For illustrative purposes, the following description of process 500 may refer to elements mentioned above in connection with FIGS. 1-4. In practical embodiments, portions of process 500 may be performed by different elements of the described system, e.g., component computing device 202 or presence indicator device 204. It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein.

Presence indication process 500 may begin by hosting the collaborative communication application on a computing device (task 502). In this example, the computing device represents a computer being used by the first person or local user as mentioned above. Process 500 obtains real-time user presence status information (task 504) from the appropriate source, e.g., a remote database, a memory of the computing device, a component of the collaborative communication application itself, or the like. In one example embodiment, the users of the collaborative communication application include the local user of the computing device and the real-time user presence status information includes the presence status information for the local user. In another example embodiment, the users of the collaborative communication application include the local user of the computing device and a remote or third person user capable of communicating with the local user via the collaborative communication application. In this embodiment, the real-time user presence status information includes the presence status information for the remote user.

Presence indication process 500 may process the real-time user presence status information (task 506) in an appropriate manner. Task 506 processes presence status information for at least one user of the collaborative communication application. In example embodiments, task 506 may process presence status information for all of the users of the collaborative communication application, including the local user and any remote users for which the presence indicator device is configured.

For illustrative purposes, FIG. 5 assumes that an indicator driver is realized in either the computing device or the presence indicator device. If the computer system includes the indicator driver (query task 508), then presence indication process 500 may proceed to a task 510. If, on the other hand, the presence indicator device includes the indicator driver, then process 500 may instead proceed to a task 516. Referring to task 510, the system-based indicator driver generates one or more indicator actuator signals in response to the current presence status information. The indicator actuator signals will convey the desired real-time user presence status information. Eventually, the presence indicator device receives the indicator actuator signals (task 512) and generates indicia (task 514) of the current presence status for at least one user of the collaborative communication application. Depending upon the particular implementation and system configuration, task 514 may indicate the current presence status of the local user, one or more remote users, or any combination thereof. As described above, the generation of this indicia is responsive to the indicator actuator signals received by the presence indicator device.

Referring again to query task 508, if the physical presence indicator device includes the indicator driver, then the computing device or system generates one or more indicator control signals in response to the current presence status information (task 516). The indicator control signals will convey the desired real-time user presence status information. Eventually, the presence indicator device receives the indicator control signals (task 518) and the indicator driver in the presence indicator device generates one or more indicator actuation signals (task 520). The internally generated indicator actuation signals are then utilized to generate indicia (task 514) of the current presence status for at least one user of the collaborative communication application, as mentioned previously.

Following task 514, presence indication process 500 may exit or it may be re-entered at task 502 to continue monitoring for further presence status changes.

While at least one example embodiment has been presented in the foregoing detailed description, it should be appreciated that a vast number of variations exist. It should also be appreciated that the example embodiment or embodiments described herein are not intended to limit the scope, applicability, or configuration of the systems, methods, or devices in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A presence indicator device comprising:
a communication interface configured to receive indicator control signals that convey real-time user presence status for a collaborative communication application; and
a physical indication architecture coupled to the communication interface, the physical indication architecture being configured to present indicia of the real-time user presence status in response to the indicator control signals.

2. A presence indicator device according to claim 1, further comprising an indicator driver coupled between the communication interface and the physical indication architecture, the indicator driver being configured to generate, in response to the indicator control signals, indicator actuation signals for the physical indication architecture.

3. A presence indicator device according to claim 1, further comprising a user interface coupled to the physical indication architecture, the user interface being configured to generate a local indicator actuation signal for the presence indicator device, the physical indication architecture being configured to present indicia of a user-controlled status in response to the local indicator actuation signal.

4. A presence indicator device according to claim 3, the communication interface being configured to provide, in response to the local indicator actuation signal, a user presence status change command for the collaborative communication application.

5. A presence indicator device according to claim 1, the physical indication architecture comprising an illumination element, a text display element, a media player, or a mechanically actuated flag.

6. A presence indicator device according to claim 1, the physical indication architecture being configured to:
present first indicia in response to a first indicator control signal, the first indicia corresponding to an available user presence status; and
present second indicia in response to a second indicator control signal, the second indicia corresponding to an unavailable user presence status.

7. A presence indicator device according to claim 1, wherein the communication interface is compliant with USB technology, BLUETOOTH wireless technology, or IEEE 802.11 wireless technology.

8. A system for indicating user presence, the system comprising:
a computing device configured to support a collaborative communication application for a plurality of users; and
a presence indicator device in communication with the computing device, the presence indicator device comprising:
a communication interface configured to receive indicator control signals that convey real-time user presence status for at least one of the plurality of users; and
a physical indication architecture coupled to the communication interface, the physical indication architecture being configured to generate indicia of the real-time presence status in response to the indicator control signals.

9. A system according to claim 8, wherein the presence indicator device is distinct from the computing device.

10. A system according to claim 8, the computing device further comprising an indicator driver coupled to the communication interface, the indicator driver being configured to generate the indicator control signals in response to manipulation of the collaborative communication application.

11. A system according to claim 8, the presence indicator device further comprising a user interface coupled to the physical indication architecture, the user interface being configured to generate a local indicator actuation signal for the presence indicator device, the physical indication architecture being configured to present indicia of a user-controlled status in response to the local indicator actuation signal.

12. A system according to claim 8, further comprising a computer accessory device coupled to the computing device, wherein the presence indicator device is incorporated into the computer accessory device.

13. A system according to claim 12, the computer accessory device comprising a cursor pointing device, a webcam device, a keyboard, a speaker, a microphone, or a display monitor.

14. A system according to claim 8, the collaborative communication application comprising a real-time messaging application, a real-time telecommunication application, or a real-time scheduling application.

15. A method for indicating presence of one or more users of a collaborative communication application, the method comprising:
hosting the collaborative communication application on a computing device;
processing real-time user presence status information for at least one user of the collaborative communication application;
receiving, at a presence indicator device coupled to the computing device, indicator control signals that convey the real-time user presence status information; and
the presence indicator device generating, in response to the indicator control signals, indicia of current presence status for the at least one user of the collaborative communication application.

16. A method according to claim 15, wherein:
users of the collaborative communication application include a local user of the computing device;
the real-time user presence status information includes presence status information for the local user; and
the presence indicator device generates indicia of the current presence status for the local user.

17. A method according to claim 15, wherein:
users of the collaborative communication application include a local user of the computing device and a remote user capable of communicating with the local user via the collaborative communication application;
the real-time user presence status information includes presence status information for the remote user; and
the presence indicator device generates indicia of the current presence status for the remote user.

18. A method according to claim 15, further comprising obtaining the real-time user presence status information from a remote database.

19. A method according to claim 15, further comprising obtaining the real-time user presence status information from the computing device.

20. A method according to claim 15, further comprising:
generating, independently from the collaborative communication application, a local indicator actuation signal for the presence indicator device; and
the presence indicator device generating, in response to the local indicator actuation signal, indicia of a local-controlled presence status for the at least one user of the collaborative communication application.
